(19) United States
(12) Patent Application Publication
(10) Pub. No.: US 2014/0222465 A1
(43) Pub. Date: Aug. 7, 2014

(54) BEDSIDE PATIENT INTERACTION SYSTEM AND METHOD

(71) Applicants: Steven Juliver, Tucson, AZ (US); Tammy Kastre, Tucson, AZ (US); Damian Hagge, Benson, AZ (US); Austin Baum, Tucson, AZ (US); Zachary Breckenridge, Tucson, AZ (US)

(72) Inventors: Steven Juliver, Tucson, AZ (US); Tammy Kastre, Tucson, AZ (US); Damian Hagge, Benson, AZ (US); Austin Baum, Tucson, AZ (US); Zachary Breckenridge, Tucson, AZ (US)

(21) Appl. No.: 14/172,890

(22) Filed: Feb. 4, 2014

Related U.S. Application Data
(60) Provisional application No. 61/760,669, filed on Feb. 5, 2013.

(51) Int. Cl. G06F 19/00

(52) U.S. Cl. CPC G06F 19/322
USPC 705/3

(57) ABSTRACT

A method, apparatus, and system of bedside patient interaction through a secure, regulation compliant interaction device. A bedside interaction method includes determining an identity of a patient constrained to a bed through an interaction device using a processor and a memory, accessing an electronic medical record of the patient constrained to the bed, monitoring a behavior of the patient interacting with the interaction device, and automatically updating the electronic medical record based on the monitoring. Privacy may be maintained through the interaction device when the interaction device is enabled to work. An encrypted access methodology may be provided to the interaction device that may be tied to when the patient is physically at the bed to ensure regulatory compliance. A multi-tier access methodology may be provided through the interaction device each time the patient interacts with it to comply with regulatory requirements.

### PRIORITY CLAIM

This disclosure claims priority to U.S. provisional patent application No. 61/760,669 filed on Feb. 5, 2013.

### FIELD OF TECHNOLOGY

This disclosure relates generally to the technical fields of communications and, in one example embodiment, to a method, apparatus, and system of bedside patient interaction through a secure, regulation compliant interaction device.

### BACKGROUND

A patient may be confined to a bed (e.g., in a hospital, a medical treatment facility). The patient may wish to communicate with loved ones, a kitchen, a nurse, and/or staff. However, the patient may not be able to rise from the bed. This immobility may restrict an ability of the patient to communicate. Furthermore, the patient may get bored when they are confined to the bed. Even when a television is placed in a room of the patient confined to the bed, the patient may desire contact with others. Regular contact may be difficult because the hospital may have a limited number of nurses and staff. For example, the hospital may have fewer nurses and staff than patients.

In addition, a kitchen at the hospital may have difficulty in determining what kinds of foods it should prepare each day for the patient. It may not have visibility into the likes and desires of the patient constrained to the bed. As a result, the kitchen may prepare foods that are not generally palatable for the patient. Similarly, the patient may not be able to order food from the kitchen when he/she is hungry. As a result, the patient may not eat properly. This may create strain on the patient and delay a time of recovery.

Further, the hospital may be unable to place a computing device (e.g., a tablet computer) in a room in which the patient is confined to the bed because of federal and state regulations (e.g. HIPPA regulations). Therefore, the hospital may be unable to provide meaningful interaction options to the patient. In addition, the hospital may need to manually update a medical record of the patient whenever the patient is provided with a meal and/or is treated (e.g., hand write). This may be time consuming and inefficient. For example, the patient's behavior and/or interactions with the medical staff may not automatically trigger updates to the medical record of the patient. As a result, the medical records may not accurately reflect a level of care provided to the patient.

### SUMMARY

This disclosure relates generally to the technical fields of communications and, in one example embodiment, to a method, apparatus, and system of bedside patient interaction through a secure, regulation compliant interaction device.

In one aspect, a bedside interaction method includes determining an identity of a patient constrained to a bed through an interaction device using a processor and a memory, accessing an electronic medical record of the patient constrained to the bed, monitoring a behavior of the patient interacting with the interaction device, and automatically updating the electronic medical record based on the monitoring. A privacy of the patient may be maintained through the interaction device when the interaction device may be enabled to work only when the interaction device may be in the medical treatment facility. An encrypted access methodology may be provided to the interaction device that may be tied to when the patient is physically at the bed to ensure regulatory compliance.

A multi-tier access methodology may be provided through the interaction device each time the patient interacts with it to comply with regulatory requirements. All data on the interaction device may be automatically disabled and/or erased in an event that the interaction device leaves the medical treatment facility. A set of educational videos may be provided to the patient through interaction device. The patient may be permitted to communicate through a voice chat and/or a video chat with an external party through the interaction device. A request of the patient may be processed through the interaction device.

The item (e.g., a meal, a prescription) associated with the request may be automatically ordered from any of a kitchen, a nurse station, and a community store at the medical treatment facility in which the patient may be geo-spatially constrained. An account associated with the patient may be billed through the interaction device. The patient constrained to the bed may be permitted to bi-directionally play a video game through the interaction device. A menu of audio-visual items may be presented to the patient through the interaction device.

The audio-visual items may be a movie, a news program, a television program, and a set of interactive games. An appropriate subset of patient education videos may be correlated with of a physical need, a physiological need, and/or a mental health need associated with the patient based on the automated analysis of the electronic medical health record may be determined from a set of patient education videos. An organized list of the appropriate subset of patient educational videos correlated with any of the physical need, the physiological need, and/or the mental need associated with the patient may be generated based on the automated analysis of the electronic medical health record.

Interactions and/or access by the patient of the appropriate subset of the patient education videos that are correlated with any of the physical need, the physiological need, and/or the mental need associated with the patient may be monitored based on the automated analysis of the electronic medical health record. The electronic medical health record may be automatically updated based on the monitored interactions. A set of care providers may be associated with the patient based on the determination of the identity of the patient constrained to the bed through the interaction device. The set of care providers may include any of a doctor, a nurse, and/or a medical assistant.

A set of medical information associated with prevention and/or care of the patient may be presented to the user. A behavior of the patient interacting with the medical information associated with the prevention and/or care of the patient may be monitored. The electronic medical health record may be automatically updated based on a completed status of a set of modules accessed by the patient. A schedule of treatments that the patient will undergo may be automatically generated through the interaction device. The patient may be permitted to access with the schedule of treatments through the interaction device. The schedule of treatments may include any of an exercise time, a procedure, and/or a medication time.

In another aspect, a bedside interaction method includes monitoring a behavior of a patient constrained to a bed interacting with an interaction device using a processor and/and a memory, automatically updating an electronic medical record of the patient based on the monitoring, ensuring that a privacy of the patient may be maintained through the interaction device by enabling the interaction device to work only when the interaction device may be in the hospital, providing an encrypted access methodology to the interaction device that may be tied to when the patient may be physically at the bed to ensure regulatory compliance, providing a multi-tier access methodology to the interaction device each time the patient interacts with it to comply with regulatory requirements, and automatically disabling and erasing all data on the interaction device in an event that the interaction device leaves the hospital.

In yet another aspect, a system of a medical treatment facility includes a bed of a medical treatment facility, an interaction device coupled with the bed to determine an identity of a patient constrained to the bed, a network, and an electronic medical record server communicatively coupled with the interaction device through the network to automatically update itself based on a monitoring of a behavior of the patient interacting with the interaction device.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a network view of an interaction device adjacent to a bed of a patient communicating with an electronic medical record server and a nurse station through a network, according to one embodiment.

FIG. 2 is an exploded view of the interaction device of FIG. 1, according to one embodiment.

FIG. 3 is a table view of a set of records associated different patients utilizing the interaction device of FIG. 1, according to one embodiment.

FIG. 4 is an entertainment view of options presented to the patient of FIG. 1, according to one embodiment.

FIG. 5 is an initial screen view of the interaction device of FIG. 1, according to one embodiment.

FIG. 6 is a monitor view of various interaction devices coupled to the nurse station of FIG. 1, according to one embodiment.

FIG. 7 is a computer view of the interaction device of FIG. 1, according to one embodiment.

Other features of the present embodiments will be apparent from the accompanying drawings and from the detailed description that follows.

### DETAILED DESCRIPTION

This disclosure relates generally to the technical fields of communications and, in one example embodiment, to a method, apparatus, and system of bedside patient interaction through a secure, regulation compliant interaction device.

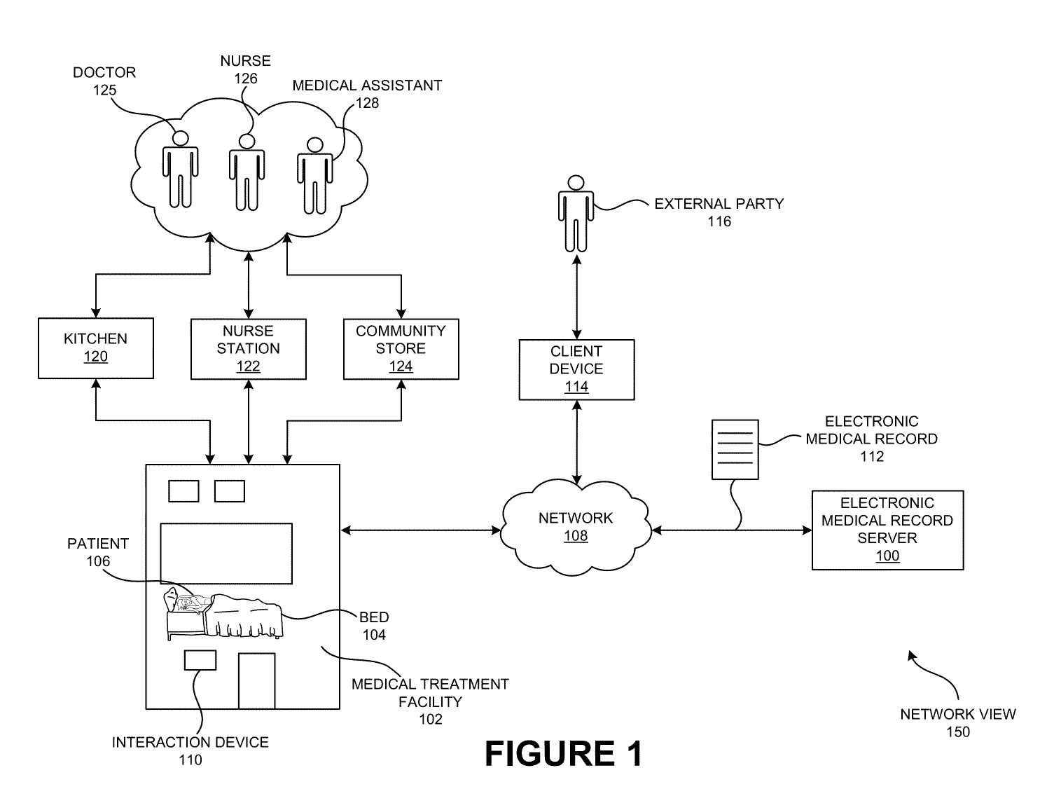

FIG. 1 is a network 108 view of an interaction device 110 adjacent to a bed 104 of a patient 106 communicating with an electronic medical record server 100 through a network 108, according to one embodiment. In the network view 150 of FIG. 1, an interaction device 110 communicates with the electronic medical record server 100 through the network 108. An external party 116 communicates with the patient 106 (e.g., who uses the interaction device coupled to the bed 104) through their client device 114. The patient 106 may be confined to the bed 104 in the medical treatment facility 102 (e.g., a hospital, a clinic).

The interaction device 110 may be a custom built tablet computing device (having a processor and a memory) designed to comply with privacy regulations such as HIPPA (Health Insurance Portability and Accountability Act of 1996) and other regulatory restrictions for use. The interaction device 110 may only work within the geo-spatial boundaries of the medical treatment facility 102, and may erase all of its data in an event that it detects that it has physically left the bed 104 in the medical treatment facility 102. In an alternate embodiment, the interaction device may be constrained to the medical treatment facility 102. For example, in an event the bed 104 is moved in the medical treatment facility 102, the interaction device 110 may be aware of and may require verification of its location and position relative to the bed 104 at runtime in order to operate.

Furthermore, a number of additional customizations may be required to the hardware of the interaction device 110. Particularly, the interaction device 110 may require patients to sign in with a multi-tier authentication methodology. Further, the interaction device 110 may automatically update the electronic medical record 112 associated with the patient 106 based on an automated monitoring of an interaction between the patient and the interaction device 110. For example, if the patient watches a video on preventive care, or orders a meal from a kitchen, the electronic medical record 112 of the patient may automatically update. An additional benefit for the interaction device 110 may be that it may be already powered, so that the patient 106 does not need to reach down and charge a personal electronic device that they may bring to the hospital.

The patient 106 (using the interaction device 110) may communicate with a doctor 125, a nurse 126, and/or a medical assistant 128. For example, the patient may order food and/or snacks from the kitchen 120 through the interaction device 110. Alternatively, the patient 106 may request assistance from the nurse 126 and/or the doctor 125 through the nurse station 122. Further, the patient 106 may order some gifts from the community store 124 at the medical treatment facility 102 through the interaction device 110.

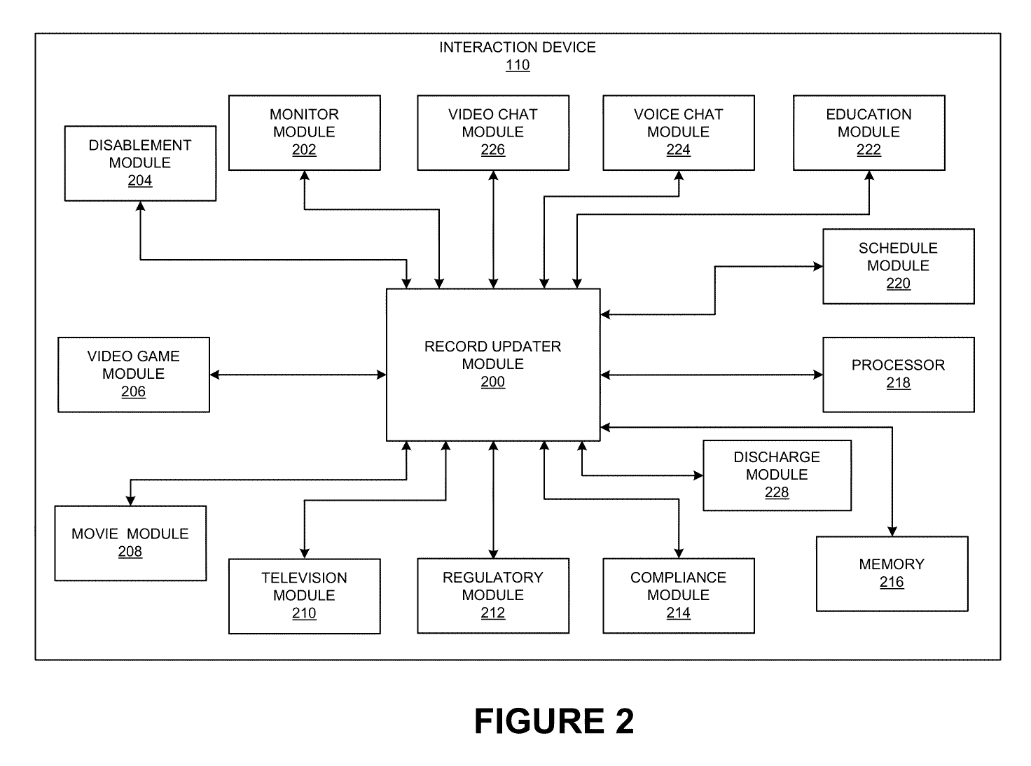

FIG. 2 is an exploded view of the interaction device 110 of FIG. 1, according to one embodiment. In FIG. 2, the interaction device 110 is illustrated as centered around a record updater module 200, according to one embodiment. The record updater module 200 may permit the patient 106 to update his/her respective medical record through the interaction device 110 in a manner that complies with all security and privacy regulations mandated by HIPPA, a state, and a local medical treatment facility. The recorder module 200 may be coupled with a number of additional submodules including a monitor module 202, a disablement module 204, a video game module 206, a movie module 208, a television module 210, a regulatory module 202, a compliance module 214, a memory 216, a processor 218, a schedule module 220, and education module 222, a voice chat module 224, a video chat module 226, and a discharge module 228.

The monitor module may keep a track of the patient 106 to ensure that the patient is not in an situation requiring immediate assistance because of drop in key vital signs. The disablement module 204 may automatically disable the interaction device 110 when the interaction device 110 is decoupled from the bed 104 and/or removed from the medical treatment facility 102. The video game module 206 may permit the patient 106 to play an interactive video game to challenge, inspire, and keep mental clarity for the patient 106 constrained to the bed through interactive education and entertainment. The movie module 208 and the television module 210 may enable the patient 106 to passively watch television and/or a movie to relax and stay calm while in a busy hospital environment.

The regulatory module 212 may ensure that the interaction device 110 complies with all regulatory requirements to ensure safe, secure, and private access to medical records of the patient 106. In addition, the compliance module 214 may generate reports to ensure that compliance with regulatory procedures are maintained. The processor 218 and the memory 216 may operate in concert using logic functions and internal circuitry to ensure that each module of the interaction device 110 works as designed through a computing system of the interaction device 110 using the processor 218 and the memory 216. The education module 222 may provide interactive educational opportunities to the patient 106. The voice chat module 224 and the video chat module 226 may provide interactive mechanisms for voice and video chats between the patient 106 and friends and loved ones outside the medical treatment facility 102. The discharge module 228 may assist in a transition of care of the patient 106 from in-patient to outpatient status. For example the discharge module 228 may ensure that a checklist of procedures and policies are followed prior to the patient 106 being discharged from the medical treatment facility 102 to minimize risk of issues (e.g., accidents, legal liability) when the patient 106 is discharged.

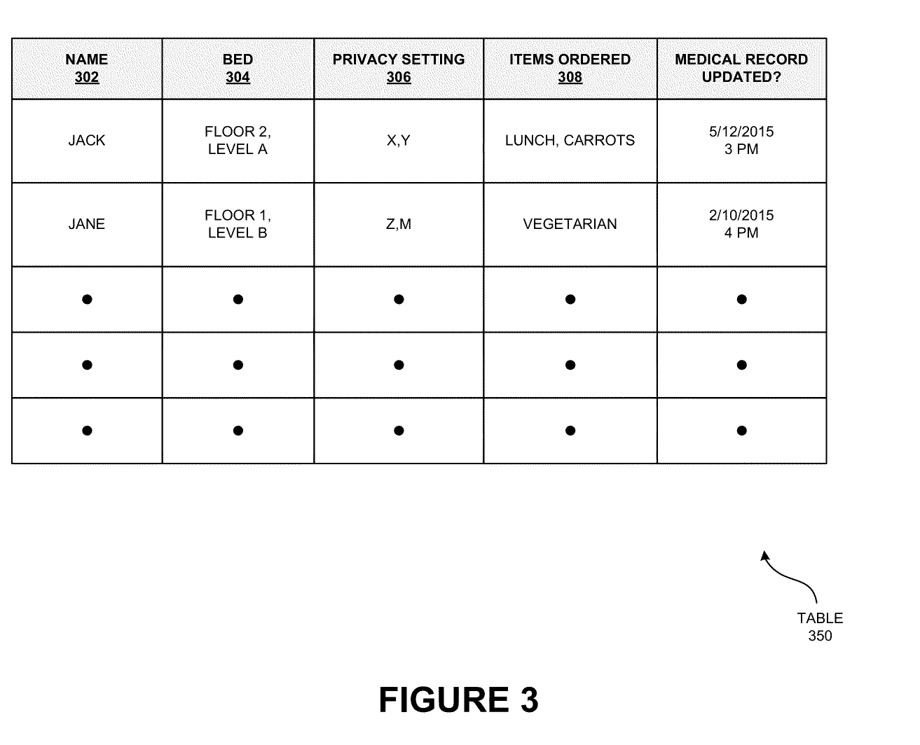

FIG. 3 is a table view 350 of a set of records associated different patients utilizing the interaction device 110 of FIG. 1, according to one embodiment. In FIG. 3, a set of different patients (e.g., the patient 106) are associated with respective interaction device preferences. The table view 350 of FIG. 3 illustrates a name field 302, a bed field 304, a privacy setting 306, an items ordered field 308, and a medical record update setting. A number of different patient records are securely stored in the table view 350 as illustrated in compliance with all regulatory and security policies (e.g., HIPPA). The various modules of FIG. 2 such as the regulatory module 212 and the compliance module 214 operate in concert to ensure regulatory compliance, according to one embodiment of the table view 350 of FIG. 3.

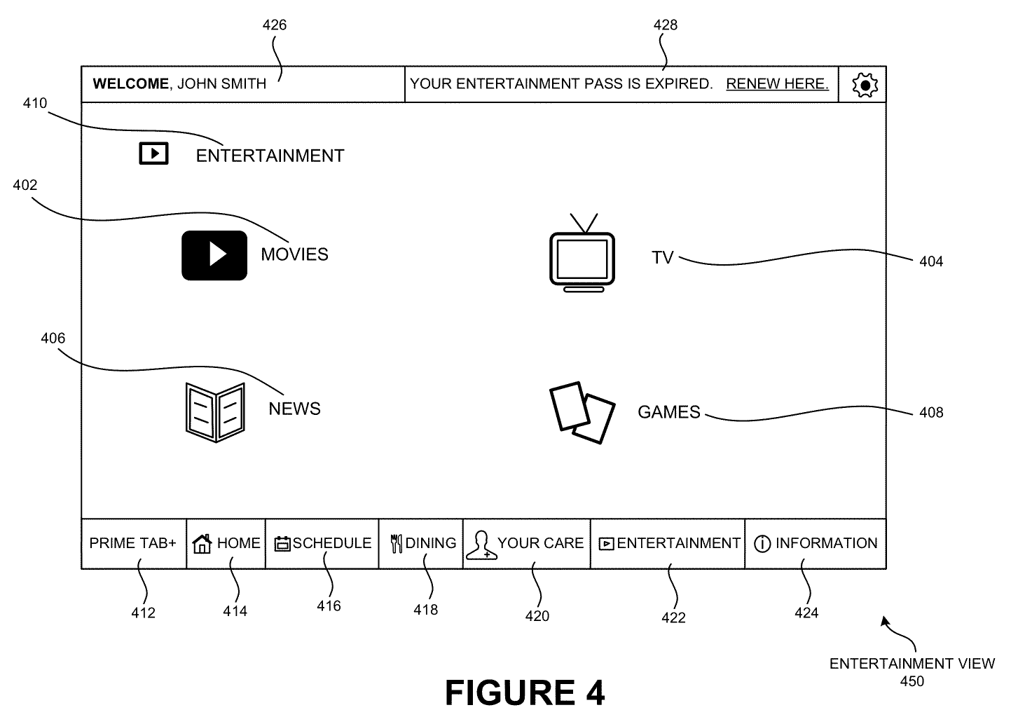

FIG. 4 is an entertainment view 450 of options presented to the patient 106 of FIG. 1, according to one embodiment. In FIG. 4, a user ‘John Smith’ is illustrated in 426. The user 426 may purchase an entertainment pass through the indicator 428, thereby providing more revenue to the medical treatment facility 102. For example, the user 426 may need to purchase an entertainment pass in order to view movies, games and/or television. The entertainment indicator 410 indicates an available choice of movies 402, television 404, news programming 406, and games 408 that the patient 106 may access through interaction device 110. A number of election choices are indicated in a bottom navigation panel, including a prime tab home page indicator 412, a home button 414, a schedule 416, a set of dining choices 418, a personal care indicator 420, an entertainment options 422, and a general information 424.

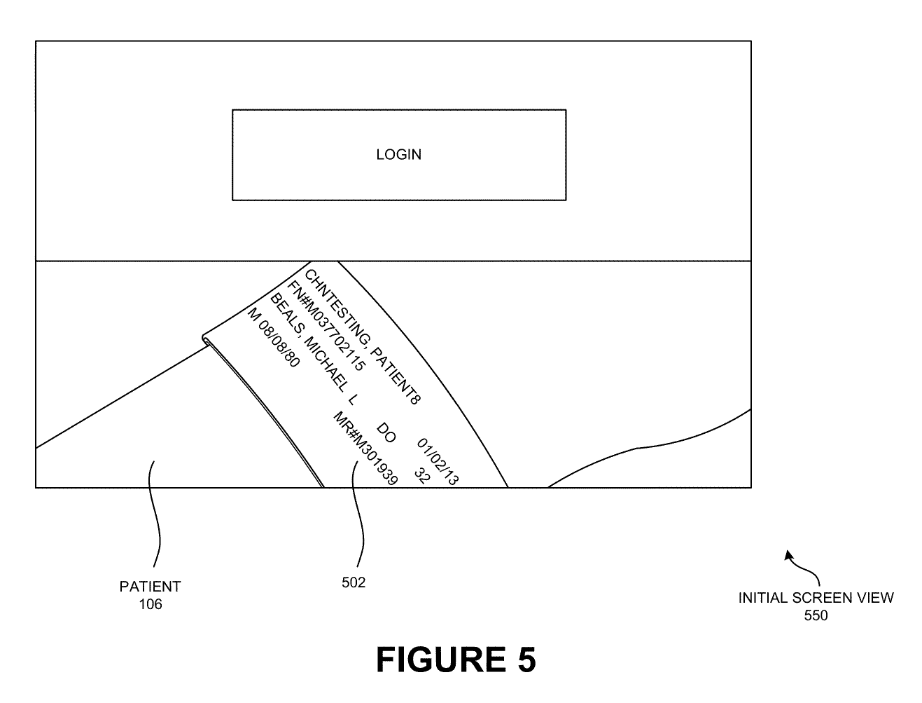

FIG. 5 is an initial screen view 550 of the interaction device 110 of FIG. 1, according to one embodiment. FIG. 5 illustrates a wristband 502 on the patient 106 which provides an access credential to the interaction device 110, according to one embodiment directly on a person of the patient 106 according to one embodiment.

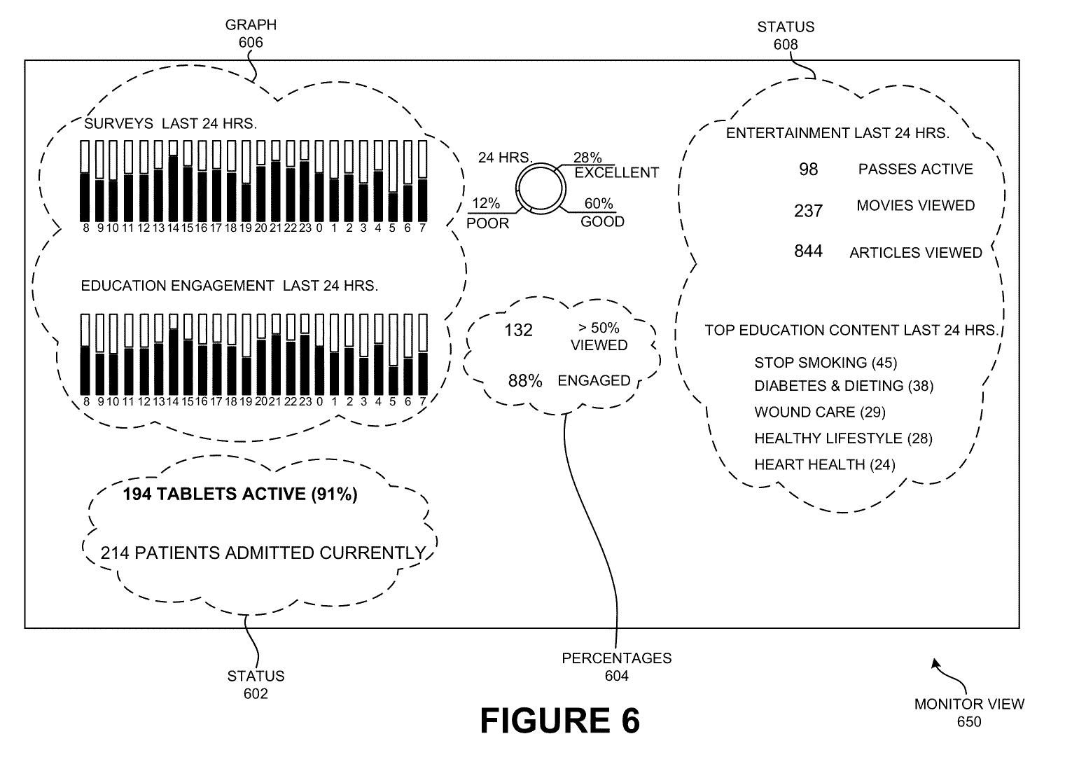

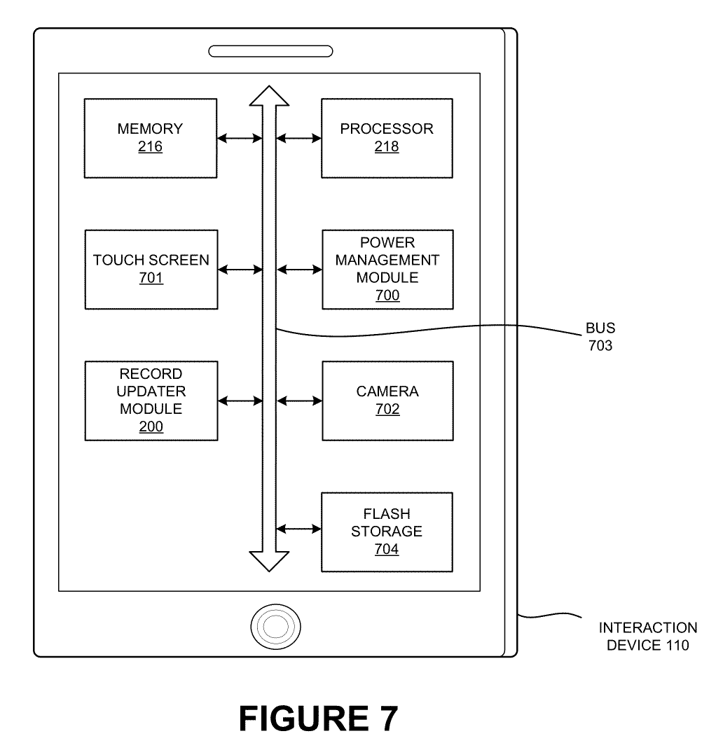

FIG. 6 is a monitor view 650 of various interaction devices on the nurse station 122 of FIG. 1 is illustrated, according to one embodiment. In FIG. 6, a status of the patients is centrally monitored through the nurse station 122 through the ‘status’ view 602. The percentages view 604 show relative percentages of users viewing and engaging their interaction devices. The users may be patients confined to beds. The graph 606 illustrates an engagement level and surveys associated with patients at the medical treatment facility 102. The additional status 608 illustrates behavioral patterns that can guide decision making and educational viewing by patients in furtherance of health goals. FIG. 7 is a computer view illustrating the processor 218 and memory 216 (of FIG. 2) communicating with a touch screen 701, a record updater module 202, a power management module 700, a camera 702, and a flash storage 704 through a bus 703 of the interaction device 110 according to one embodiment.

In one embodiment, a bedside interaction method includes determining an identity of a patient 106 constrained to a bed 104 through an interaction device 110 using a processor 218 and a memory 216, accessing an electronic medical record 112 of the patient 106 constrained to the bed 104, monitoring a behavior of the patient 106 interacting with the interaction device 110, and automatically updating the electronic medical record 112 based on the monitoring. A privacy of the patient 106 may be maintained through the interaction device 110 when the interaction device 110 may be enabled to work only when the interaction device 110 may be in the medical treatment facility 102 (e.g., a hospital, an urgent care center, a long term care center, a hospice, a clinic). An encrypted access methodology may be provided to the interaction device 110 that may be tied to when the patient 106 is physically at the bed 104 to ensure regulatory compliance.

A multi-tier access methodology may be provided through the interaction device 110 each time the patient 106 interacts with it to comply with regulatory requirements (e.g., using the regulatory module 212 of FIG. 2). All data on the interaction device 110 may be automatically disabled and/or erased (e.g., using the disablement module 204 of FIG. 2) in an event that the interaction device 110 leaves the medical treatment facility 102 (e.g., a hospital, an urgent care center, a long term care center, a hospice, a clinic). A set of educational videos may be provided to the patient 106 through interaction device 110. The patient 106 may be permitted to communicate through a voice chat and/or a video chat with an external party through the interaction device 110. A request of the patient 106 may be processed through the interaction device 110.

The item (e.g., a meal, a prescription) associated with the request may be automatically ordered from any of a kitchen 120, a nurse station 122, and a community store 124 at the medical treatment facility 102 (e.g., a hospital, an urgent care center, a long term care center, a hospice, a clinic) in which the patient 106 may be geo-spatially constrained. An account associated with the patient 106 may be billed through the interaction device 110. The patient 106 constrained to the bed 104 may be permitted to bi-directionally play a video game through the interaction device 110. A menu of audio-visual items may be presented to the patient 106 through the interaction device 110.

The audio-visual items may be a movie, a news program, a television program, and a set of interactive games (e.g., using the video game module 206). An appropriate subset of patient 106 education videos may be correlated with of a physical need, a physiological need, and/or a mental health need associated with the patient 106 based on the automated analysis of the electronic medical health record may be determined from a set of patient 106 education videos. An organized list of the appropriate subset of patient 106 educational videos correlated with any of the physical need, the physiological need, and/or the mental need associated with the patient 106 may be generated based on the automated analysis of the electronic medical health record.

Interactions and/or access by the patient 106 of the appropriate subset of the patient 106 education videos that are correlated with any of the physical need, the physiological need, and/or the mental need associated with the patient 106 may be monitored based on the automated analysis of the electronic medical health record. The electronic medical health record may be automatically updated based on the monitored interactions. A set of care providers may be associated with the patient 106 based on the determination of the identity of the patient 106 constrained to the bed 104 through the interaction device 110. The set of care providers may include any of a doctor 125, a nurse 126, and/or a medical assistant 128.

A set of medical information associated with prevention and/or care of the patient 106 may be presented to the user (e.g., the patient 106). A behavior of the patient 106 interacting with the medical information associated with the prevention and/or care of the patient 106 may be monitored. The electronic medical health record 112 may be automatically updated based on a completed status of a set of modules accessed by the patient 106. A schedule of treatments that the patient 106 will undergo may be automatically generated through the interaction device 110. The patient 106 may be permitted to access with the schedule of treatments through the interaction device 110. The schedule of treatments may include any of an exercise time, a procedure, and/or a medication time.

In another embodiment, a bedside interaction method includes monitoring a behavior of a patient 106 constrained to a bed 104 interacting with an interaction device 110 using a processor 218 and/and a memory 216, automatically updating an electronic medical record 112 of the patient 106 based on the monitoring, ensuring that a privacy of the patient 106 may be maintained through the interaction device 110 by enabling the interaction device 110 to work only when the interaction device 110 may be in the hospital, providing an encrypted access methodology to the interaction device 110 that may be tied to when the patient 106 may be physically at the bed 104 to ensure regulatory compliance, providing a multi-tier access methodology to the interaction device 110 each time the patient 106 interacts with it to comply with regulatory requirements (e.g., using the regulatory module 212 of FIG. 2), and automatically disabling and erasing all data on the interaction device 110 in an event that the interaction device 110 leaves the hospital.

In yet another embodiment, a system of a medical treatment facility 102 (e.g., a hospital, an urgent care center, a long term care center, a hospice, a clinic) includes a bed 104 of a medical treatment facility 102 (e.g., a hospital, an urgent care center, a long term care center, a hospice, a clinic), an interaction device 110 coupled with the bed 104 to determine an identity of a patient 106 constrained to the bed 104, a network 108, and an electronic medical record server 100 communicatively coupled with the interaction device 110 through the network 108 to automatically update itself based on a monitoring of a behavior of the patient 106 interacting with the interaction device 110.

A patient Bob Jones may be confined to a bed (e.g., in a hospital, a medical treatment facility). Bob Jones may wish to communicate with loved ones (his wife Mabel). He may also want to order a salad from the kitchen of the hospital. Bob may wonder what is on the menu, and what is his schedule for the next day. Using the interaction device and the various embodiments described herein, Bob may get answers to his questions. In addition, Bob may be able to speak with friends and loved ones through the interaction device as described in the various embodiments described herein. He may able to play games through the interaction device, and learn about how to care for himself and his condition through the interaction device. This may prevent boredom, and help to Bob recover more quickly thanks to the various embodiments described herein.

The methods, systems, and apparatuses disclosed herein may be implemented in any means for achieving various embodiments, and may be executed in a form of a machine-readable medium embodying a set of instructions that, when executed by a machine, cause the machine to perform any of the operations disclosed herein. Although the present embodiments have been described with reference to specific example embodiments, it will be evident that various modifications and changes may be made to these embodiments without departing from the broader spirit and scope of the various embodiments.

For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and/or electrical circuits (e.g., Application Specific Integrated Circuitry (ASIC), Digital Signal Processor (DSP) circuitry, etc.). For example modules of each of the Figures may be enabled using electronic circuits using one or more of the technologies described herein.

In addition, it will be appreciated that the various operations, processes, and methods disclosed herein may be embodied in a machine-readable medium and or a machine accessible medium compatible with a data processing system (e.g., a computer system), and may be performed in any order. Accordingly, the specification and drawings are to be regarded in an illustrative rather than a restrictive sense.

What is claimed is:

1. A bedside interaction method, comprising:
determining an identity of a patient constrained to a bed through an interaction device using a processor and a memory;
accessing an electronic medical record of the patient constrained to the bed;
monitoring a behavior of the patient interacting with the interaction device; and
automatically updating the electronic medical record based on the monitoring.

2. The bedside interaction method of claim 1 further comprising:
ensuring that a privacy of the patient is maintained through the interaction device by enabling the interaction device to work only when the interaction device is in the hospital;
providing an encrypted access methodology to the interaction device that is tied to when the patient is physically at the bed to ensure regulatory compliance;
providing a multi-tier access methodology to the interaction device each time the patient interacts with it to comply with regulatory requirements;
automatically disabling and erasing all data on the interaction device in an event that the interaction device leaves the hospital;
providing a set of educational videos to the patient through interaction device;
permitting the patient to communicate through at least one of a voice chat and a video chat with an external party through the interaction device;
processing a request of the patient through the interaction device;
automatically ordering the item associated with the request from at least one of a kitchen, a nurse station, and a community store at the hospital in which the patient is geo-spatially constrained; and
billing an account associated with the patient through the interaction device.

3. The bedside interaction method of claim 2 further comprising:
permitting the patient constrained to the bed to bi-directionally play a video game through the interaction device; and
presenting a menu of audio-visual items to the patient through the interaction device, wherein the audio-visual items comprise at least one of a movie, a news program, a television program, and a set of interactive games.

4. The bedside interaction method of claim 3 further comprising:
determining, from a set of patient education videos, an appropriate subset of patient education videos that are correlated with at least one of a physical need, a physiological need, and a mental health need associated with the patient based on the automated analysis of the electronic medical health record; and
generating an organized list of the appropriate subset of patient educational videos that are correlated with the at least one of the physical need, the physiological need, and the mental need associated with the patient based on the automated analysis of the electronic medical health record.

5. The bedside interaction method of claim 4 further comprising:
monitoring interactions and access by the patient of the appropriate subset of the patient education videos that are correlated with the at least one of the physical need, the physiological need, and the mental need associated with the patient based on the automated analysis of the electronic medical health record; and
automatically updating the electronic medical health record based on the monitored interactions.

6. The bedside interaction system of claim 5 further comprising
associating a set of care providers with the patient based on the determination of the identity of the patient constrained to the bed through the interaction device,
wherein the set of care providers include at least one of a doctor, a nurse, and a medical assistant;
presenting to the user a set of medical information associated with prevention and care of the patient;
monitoring a behavior of the patient interacting with the medical information associated with the prevention and care of the patient; and
automatically updating the electronic medical health record based on a completed status of a set of modules accessed by the patient.

7. The bedside interaction system of claim 6 further comprising:
automatically generating a schedule of treatments that the patient is calendared to undergo through the interaction device; and
permitting the patient to access with the schedule of treatments through the interaction device,
wherein the schedule of treatments include at least one of an exercise time, a procedure, a medication time.

8. A bedside interaction method, comprising:
monitoring a behavior of a patient constrained to a bed interacting with an interaction device using a processor and a memory;
automatically updating an electronic medical record of the patient based on the monitoring;
ensuring that a privacy of the patient is maintained through the interaction device by enabling the interaction device to work only when the interaction device is in the hospital;
providing an encrypted access methodology to the interaction device that is tied to when the patient is physically at the bed to ensure regulatory compliance;
providing a multi-tier access methodology to the interaction device each time the patient interacts with it to comply with regulatory requirements; and
automatically disabling and erasing all data on the interaction device in an event that the interaction device leaves the hospital.

9. The bedside interaction method of claim 8 further comprising:
determining an identity of the patient constrained to the bed through the interaction device;
accessing the electronic medical record of the patient constrained to the bed;
providing a set of educational videos to the patient through interaction device;
permitting the patient to communicate through at least one of a voice chat and a video chat with an external party through the interaction device;
processing a request of the patient through the interaction device;
automatically ordering the item associated with the request from at least one of a kitchen, a nurse station, and a community store at the hospital in which the patient is geo-spatially constrained; and
billing an account associated with the patient through the interaction device.

10. The bedside interaction method of claim 9 further comprising:
permitting the patient constrained to the bed to bi-directionally play a video game through the interaction device; and
presenting a menu of audio-visual items to the patient through the interaction device, wherein the audio-visual items comprise at least one of a movie, a news program, a television program, and a set of interactive games.

11. The bedside interaction method of claim 10 further comprising:
determining, from a set of patient education videos, an appropriate subset of patient education videos that are correlated with at least one of a physical need, a physiological need, and a mental health need associated with the patient based on the automated analysis of the electronic medical health record; and
generating an organized list of the appropriate subset of patient educational videos that are correlated with the at least one of the physical need, the physiological need, and the mental need associated with the patient based on the automated analysis of the electronic medical health record.

12. The bedside interaction method of claim 11 further comprising:
monitoring interactions and access by the patient of the appropriate subset of the patient education videos that are correlated with the at least one of the physical need, the physiological need, and the mental need associated with the patient based on the automated analysis of the electronic medical health record; and
automatically updating the electronic medical health record based on the monitored interactions.

13. The bedside interaction system of claim 12 further comprising
associating a set of care providers with the patient based on the determination of the identity of the patient constrained to the bed through the interaction device,
wherein the set of care providers include at least one of a doctor, a nurse, and a medical assistant;
presenting to the user a set of medical information associated with prevention and care of the patient;
monitoring a behavior of the patient interacting with the medical information associated with the prevention and care of the patient; and
automatically updating the electronic medical health record based on a completed status of a set of modules accessed by the patient.

14. The bedside interaction system of claim 13 further comprising:
automatically generating a schedule of treatments that the patient is calendared to undergo through the interaction device; and
permitting the patient to access with the schedule of treatments through the interaction device,
wherein the schedule of treatments include at least one of an exercise time, a procedure, a medication time.

15. A system of a medical treatment facility, comprising:
a bed of a medical treatment facility;
an interaction device coupled with the bed to determine an identity of a patient constrained to the bed;
a network; and
an electronic medical record server communicatively coupled with the interaction device through the network to automatically update itself based on a monitoring of a behavior of the patient interacting with the interaction device.

16. The system of the medical treatment facility of claim 15:
wherein a privacy of the patient is maintained through the interaction device when the interaction device is enabled to work only when the interaction device is in the medical treatment facility,
wherein an encrypted access methodology is provided to the interaction device that is tied to when the patient is physically at the bed to ensure regulatory compliance,
wherein a multi-tier access methodology is provided through the interaction device each time the patient interacts with it to comply with regulatory requirements,
wherein all data on the interaction device is automatically disabled and erased in an event that the interaction device leaves the medical treatment facility,
wherein a set of educational videos are provided to the patient through interaction device,
wherein the patient is permitted to communicate through at least one of a voice chat and a video chat with an external party through the interaction device,
wherein a request of the patient is processed through the interaction device,
wherein the item associated with the request is automatically ordered from at least one of a kitchen, a nurse station, and a community store at the medical treatment facility in which the patient is geo-spatially constrained, and
wherein an account associated with the patient is billed through the interaction device.

17. The system of the medical treatment facility of claim 16:
wherein the patient constrained to the bed is permitted to bi-directionally play a video game through the interaction device, and
wherein a menu of audio-visual items is presented to the patient through the interaction device, wherein the audio-visual items comprise at least one of a movie, a news program, a television program, and a set of interactive games.

18. The system of the medical treatment facility of claim 17:
wherein an appropriate subset of patient education videos that are correlated with at least one of a physical need, a physiological need, and a mental health need associated with the patient based on the automated analysis of the electronic medical health record is determined from a set of patient education videos, and
wherein an organized list of the appropriate subset of patient educational videos that are correlated with the at least one of the physical need, the physiological need, and the mental need associated with the patient based on the automated analysis of the electronic medical health record are generated.

19. The system of the medical treatment facility of claim 18:
wherein interactions and access by the patient of the appropriate subset of the patient education videos that are correlated with the at least one of the physical need, the physiological need, and the mental need associated with the patient based on the automated analysis of the electronic medical health record are monitored, and
wherein the electronic medical health record based on the monitored interactions are automatically updated.

20. The system of the medical treatment facility of claim 19:
wherein a set of care providers with the patient based on the determination of the identity of the patient constrained to the bed through the interaction device are associated,
wherein the set of care providers include at least one of a doctor, a nurse, and a medical assistant,
wherein a set of medical information associated with prevention and care of the patient are presented to the user,
wherein a behavior of the patient interacting with the medical information associated with the prevention and care of the patient is monitored,
wherein the electronic medical health record is automatically updated based on a completed status of a set of modules accessed by the patient,
wherein a schedule of treatments that the patient is calendared to undergo through the interaction device is automatically generated, and
wherein the patient to access with the schedule of treatments through the interaction device is permitted, and
wherein the schedule of treatments include at least one of an exercise time, a procedure, a medication time.
